(19) United States
(12) Patent Application Publication
(10) Pub. No.: US 2006/0024059 A1
(43) Pub. Date: Feb. 2, 2006

(54) Bi-directional optical add-drop multiplexer

(75) Inventors: Sung-Bum Park, Suwon-si (KR); Kee-Sung Nam,, Seoul (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/005,206

(22) Filed: Dec. 6, 2004

(30) Foreign Application Priority Data
Jul. 30, 2004 (KR) 2004-60290

(51) Int. Cl. H04J 14/02

(52) U.S. Cl. 398/83

(57) ABSTRACT

A bi-directional optical add-drop multiplexer is disclosed. The multiplexer includes at least two couples of optical elements including a wavelength division multiplexer and an optical circulator. Each of the wavelength division multiplexer demultiplexes one of a first WDM optical signal and a second WDM optical signal transmitted in opposite directions through one optical transmission line between nodes of a bi-directional WDM optical communication network, drops an optical signal having a predetermined wavelength from the demultiplexed signals, and adds an optical signal having a predetermined wavelength to the other of the first WDM optical signal and the second WDM optical signal. The optical circulator separates routes for the signals dropped and added by a corresponding wavelength division multiplexer. The bi-directional optical add-drop multiplexer can prevent or reduce degradation of optical signal transmission quality due to crosstalk between an added optical signal and a dropped optical signal.

### BI-DIRECTIONAL OPTICAL ADD-DROP MULTIPLEXER CLAIM OF PRIORITY

This application claims priority to an application entitled “Bi-directional Optical Add-Drop Multiplexer,” filed in the Korean Industrial Property Office on Jul. 30, 2004 and assigned Serial No. 2004-60290, the contents of which are hereby incorporated by reference.

### BACKGROUND OF THE INVENTION

1. Field of the Invention

The present invention relates to a bi-directional Wavelength Division Multiplexing (WDM) optical communication network, and more particularly to a bi-directional optical Add-Drop Multiplexer (ADM) that can add/drop an optical signal having a predetermined wavelength to/from WDM optical signals transmitted in two opposite directions along one optical transmission line between nodes.

2. Description of the Related Art

Metro access networks must be capable of providing higher speed service in order to meet the increasing demand for ultra high speed services, as well as being economical in order to accept a large number of subscribers. A metro access network employing a WDM technique can transmit an optical signal wavelength-division-multiplexed with multiple wavelengths regardless of transmission method or transmission speed and thus can efficiently achieve the ultra high speed and broadband for the network.

In a bi-directional WDM optical communication network, which can be used as the metro access network, two WDM optical signals can be transmitted in opposite directions through one optical transmission line connected between nodes of the network. For example, an optical signal wavelength-division-multiplexed from optical signals corresponding to odd-numbered channel is transmitted in one direction and an optical signal wavelength-division-multiplexed from optical signals corresponding to even-numbered channels is transmitted towards the opposite direction in the optical communication system.

Each node of the bi-directional WDM optical communication network can drop a predetermined signal from and add a predetermined signal to the network. Therefore, each node is required to include a bi-directional optical add-drop multiplexer that can drop a predetermined signal from and add a predetermined signal to WDM optical signals transmitted in opposite directions.

FIG. 1 is a diagram showing a conventional bi-directional optical add-drop multiplexer. The bi-directional optical add-drop multiplexer is connected to optical transmission lines 100 and 102 through which two WDM optical signals are transmitted in opposite directions between nodes of a bi-directional WDM optical communication network. Each of the optical transmission lines 100 and 102 is connected to one of the nodes of the bidirectional WDM optical communication network.

In the bidirectional optical add-drop multiplexer shown in FIG. 1, two WDM optical signals introduced through the optical transmission lines 100 and 102 are respectively divided by 3-port optical circulators 104 and 118. An optical signal having a predetermined optical wavelength is dropped from and added to one of the two WDM optical signals introduced through the optical transmission line 100 by optical circulators 106 and 114. An optical wavelength selector 110 and another optical signal having a predetermined optical wavelength is dropped from and added to the other of the two WDM optical signals introduced through the optical transmission line 102 by optical circulators 108 and 116 and an optical wavelength selector 112. Herein, the dropped signal and the added signal have the same wavelength. When an optical signal has been dropped from the WDM optical signal introduced in one direction, an optical signal having the same wavelength as that of the dropped optical signal is added to the WDM optical signal, which is then transmitted in the same direction.

In the bi-directional optical add-drop multiplexer shown in FIG. 1, an optical signal in which three optical signals having wavelengths of λ2, λ4 and λ6 have been wavelength-division-multiplexed is introduced through the optical transmission line 100. An optical signal in which three optical signals having wavelengths of λ1, λ3 and λ5 have been wavelength-division-multiplexed is introduced through the optical transmission line 102. An optical signal having a wavelength of λ2 is dropped from the WDM optical signal having wavelengths of λ2, λ4 and λ6. Also, an optical signal having a wavelength of λ1 is dropped from the WDM optical signal having wavelengths of λ1, λ3 and λ5.

The WDM optical signal having wavelengths of λ2, λ4 and λ6 is introduced to a node 104a of the optical circulator 104 through the optical transmission line 100 and the WDM optical signal having wavelengths of λ1, λ3 and λ5 is introduced to a node 118a of the optical circulator 118 through the optical transmission line 102. Each of the optical circulators 104, 106, 108, 114, 116 and 118 is a 3-port optical circulator having circularly arranged three ports, in which an optical signal introduced through each port is output to an adjacent port located next to the input port in a clockwise or counterclockwise direction as shown by clockwise or counterclockwise arrows in FIG. 1.

In this way, the WDM optical signal having wavelengths of λ2, λ4 and λ6 introduced into the node 104a of the optical circulator 104 is output through a node 104b of the optical circulator 104 and progresses sequentially through the optical circulator 106. The optical wavelength selector 110 and the optical circulator 114 (constructing the upper route in FIG. 1) and the WDM optical signal having wavelengths of λ1, λ3 and λ5 introduced into the node 118a of the optical circulator 118 is output through a node 118b of the optical circulator 118 and progresses sequentially through the optical circulator 116, the optical wavelength selector 112 and the optical circulator 108 (constructing the lower route in FIG. 1). In the bi-directional optical add-drop multiplexer shown in FIG. 1, the optical wavelength selector 110 reflects an optical signal having a wavelength of λ2 and the optical wavelength selector 112 reflects an optical signal having a wavelength of λ1. The optical wavelength selectors 110 and 112 reflect the optical signals having the wavelengths of λ2 and λ1, respectively, and allow optical signals having the other wavelengths to pass through them.

The WDM optical signal having the wavelengths of λ2, λ4 and λ6 having been introduced to a node 106a of the optical circulator 106 from the node 104a of the optical circulator 104 as described above is outputted through a node 106b of the optical circulator 106 and applied to the optical wavelength selector 110. Here, the optical signal having the wavelength of λ2 is reflected by the optical wavelength selector 110, is introduced back to the node 106b of the optical circulator 106, and is then output through a node 106c of the optical circulator 106, which means that the signal is dropped. Meanwhile, the WDM optical signal having the other wavelengths of λ4 and λ6 passes through the optical wavelength selector 110 and is then introduced into a node 114b of the optical circulator 114. An optical signal having the wavelength of λ2 to be added is introduced into a node 114a of the optical circulator 114. The introduced optical signal having the wavelength of λ2 is output through the node 114b of the optical circulator 114 and is then reflected by the optical wavelength selector 110, so that it is introduced into the node 114b of the optical circulator 114 together with the optical signal having the wavelengths of λ4 and λ6. Then, a WDM optical signal having the wavelengths of λ2, λ4 and λ6 is output through a node 114c of the optical circulator 114, is introduced into a node 118c of the optical circulator 118, is output through the node 118a of the optical circulator 118, and is then transmitted through the optical transmission line 102.

The WDM optical signal having the wavelengths of λ1, λ3 and λ5 having been introduced to a node 116a of the optical circulator 116 from the node 118b of the optical circulator 118 as described above is output through a node 116b of the optical circulator 116 and applied to the optical wavelength selector 112. Here, the optical signal having the wavelength of λ1 is reflected by the optical wavelength selector 112, is introduced back to the node 116b of the optical circulator 116, and is then output through a node 116c of the optical circulator 116, which means that the signal is dropped. Meanwhile, the WDM optical signal having the other wavelengths of λ3 and λ5 passes through the optical wavelength selector 112 and is then introduced into a node 108b of the optical circulator 108. Also, an optical signal having the wavelength of λ1 to be added is introduced into a node 108a of the optical circulator 108. The introduced optical signal having the wavelength of λ1 is output through the node 108b of the optical circulator 108 and is then reflected by the optical wavelength selector 112, so that it is introduced to the node 108b of the optical circulator 108 together with the optical signal having the wavelengths of λ3 and λ5. Then, a WDM optical signal having the wavelengths of λ1, λ3 and λ5 is output through a node 108c of the optical circulator 108, is introduced into a node 104c of the optical circulator 104, is output through the node 104a of the optical circulator 104, and is then transmitted through the optical transmission line 100.

As described above, in bi-directional optical add-drop multiplexer shown in FIG. 1, an optical signal having a predetermined wavelength is dropped from a WDM optical signal introduced in one direction, and an optical signal having the same wavelength as that of the dropped optical signal is added to the WDM optical signal, which is then transmitted in the same direction. In the same manner, optical signals having the same predetermined wavelength are dropped from and then added to a WDM optical signal introduced in an opposite direction, respectively. As noted from the above description, a dropped optical signal and an added optical signal having the same wavelength are reflected by the same optical wavelength selector. The dropped optical signal and the added optical signal having the same wavelength of λ1 are reflected by the optical wavelength selector 112, and the dropped optical signal and the added optical signal having the same wavelength of λ2 are reflected by the optical wavelength selector 110. Since the dropped optical signal and the added optical signal have the same wavelength and are reflected by the same optical wavelength selector as described above, the quality of the dropped optical signal may be degraded due to crosstalk of the added optical signal.

In order to solve this problem, the optical wavelength selectors 110 and 112 must have a high isolation, for example, an isolation of 30 dB or more. However, a high isolation optical wavelength selector is expensive and significantly increases the manufacturing cost of the multiplexer.

Another technique for addressing the above problem is disclosed in U.S. Pat. No. 5,926,300 entitled “Optical Add-Drop Multiplexer”, issued to Miyakawa et al. on Jul. 20, 1999. That technique employs two separate optical wavelength selectors for reflecting the dropped optical signal and the added optical signal, respectively, as well as an optical isolator disposed between the two separate optical wavelength selectors. This prevents the transmission characteristics from being degraded due to leaking portion passing through the optical wavelength selectors instead of being reflected by the optical wavelength selectors.

However, while the multiplexer disclosed in U.S. Pat. No. 5,926,300 can prevent the transmission characteristics from being degraded due to leaking portion passing through the optical wavelength selectors instead of being reflected by the optical wavelength selectors, the multiplexer includes numerous optical wavelength selectors as well as an additional optical isolator, which complicate the construction of the multiplexer and increase the manufacturing cost of the multiplexer.

### SUMMARY OF THE INVENTION

One aspect of the present invention relates to a bi-directional optical add-drop multiplexer that can prevent transmission quality of an optical signal from being degraded due to crosstalk between an added optical signal and a dropped optical signal.

Another aspect of the present invention relates to a bi-directional optical add-drop multiplexer that includes a reduced number of optical elements as compared to the conventional multiplexers described above.

One embodiment of the present invention is directed to a bi-directional optical add-drop multiplexer including at least two couples of optical elements including a wavelength division multiplexer and an optical circulator. Each of the wavelength division multiplexer demultiplexes one of a first WDM optical signal and a second WDM optical signal transmitted in opposite directions through one optical transmission line between nodes of a bi-directional WDM optical communication network, drops an optical signal having a predetermined wavelength from the demultiplexed signals, and adds an optical signal having a predetermined wavelength to the other of the first WDM optical signal and the second WDM optical signal. The optical circulator separates routes for the signals dropped and added by a corresponding wavelength division multiplexer.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a diagram illustrating a conventional bi-directional optical add-drop multiplexer;

FIG. 2 is a diagram illustrating a bi-directional optical add-drop multiplexer according to an embodiment of the present invention;

FIG. 3 is a graph showing an add-drop filter characteristic of a wavelength division multiplexer according to an embodiment of the present invention;

FIG. 4 is a diagram illustrating a bi-directional optical add-drop multiplexer according to another embodiment of the present invention;

FIG. 5 is a diagram illustrating a bidirectional optical add-drop multiplexer according to another embodiment of the present invention;

FIG. 6 is a diagram illustrating a bi-directional optical add-drop multiplexer according to another embodiment of the present invention; and

FIG. 7 is a diagram illustrating a bi-directional optical add-drop multiplexer according to yet another embodiment of the present invention.

### DETAILED DESCRIPTION

Hereinafter, embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may obscure the subject matter of the present invention.

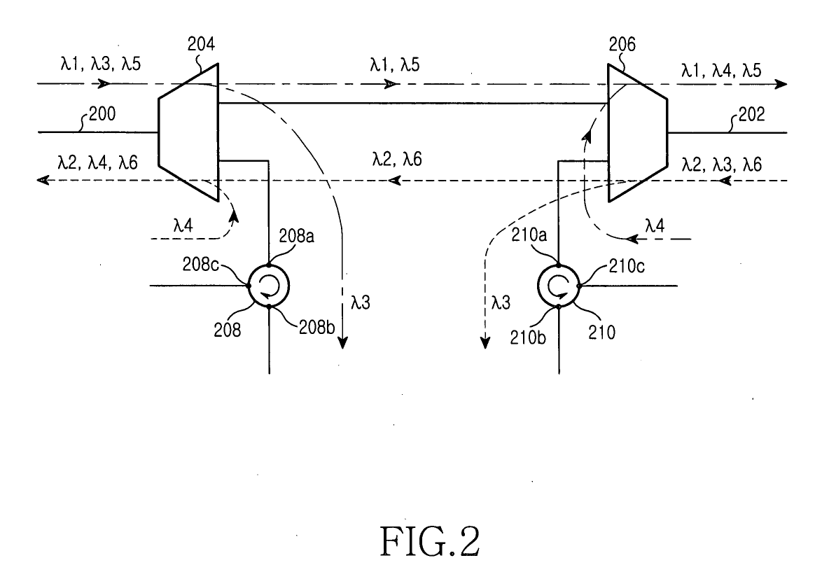

FIG. 2 is a diagram showing a bi-directional optical add-drop multiplexer according to an embodiment of the present invention. The bi-directional optical add-drop multiplexer includes a couple of optical elements including a first wavelength division multiplexer 204 and a first optical circulator 208 connected to each other and another couple of optical elements including of a second wavelength division multiplexer 206 and a second optical circulator 210 connected to each other. The first wavelength division multiplexer 204 and the second wavelength division multiplexer 206 are connected to a first and a second optical transmission line 200 and 202, respectively, through which two WDM optical signals are transmitted in opposite directions between nodes of a bi-directional WDM optical communication network. Each of the first and the second optical transmission line 200 and 202 is connected to one of the nodes of the bi-directional WDM optical communication network.

In the bi-directional optical add-drop multiplexer shown in FIG. 2, an optical signal in which three optical signals having wavelengths of λ1, λ3 and λ5 have been wavelength-division-multiplexed is introduced through the first optical transmission line 200. An optical signal in which three optical signals having wavelengths of λ2, λ3 and λ6 have been wavelength-division-multiplexed is introduced through the second optical transmission line 202. An optical signal having a wavelength of λ3 is dropped from and an optical signal having a wavelength of λ4 is then added to both the WDM optical signal having wavelengths of λ1, λ3 and λ5 and the WDM optical signal having wavelengths of λ2, λ3 and λ6. The two added optical signals in both directions have the same wavelength and the two dropped optical signals in both directions have the same wavelength, while the signals added and dropped by each wavelength division multiplexer have wavelengths different from each other.

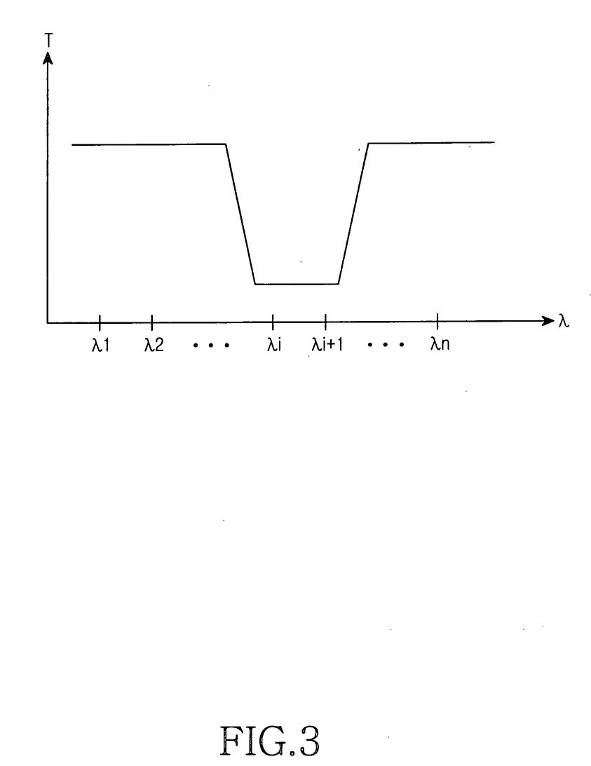

In the bi-directional optical add-drop multiplexer shown in FIG. 2, the WDM optical signal having wavelengths of λ1, λ3 and λ5 is introduced to the first wavelength division multiplexer 204 through the first optical transmission line 200. The WDM optical signal having wavelengths of λ2, λ3 and λ6 introduced is introduced to the second wavelength division multiplexer 206 through the second optical transmission line 202. Each of the first wavelength division multiplexer 204 and the second wavelength division multiplexer 206 demultiplexes an introduced WDM optical signal to drop an optical signal having a predetermined wavelength and allow optical signals having the other wavelengths to pass through it, and adds an optical signal having a predetermined wavelength to an introduced WDM optical signal through multiplexing. Each of the first and the second wavelength division multiplexer 204 and 206 has an add-drop filter characteristic capable of selectively dropping and adding only optical signals having predetermined adjacent wavelengths of λi and λi+1 as shown in FIG. 3. It is noted that the wavelengths of λi and λi+1 shown in FIG. 3 correspond to λ3 and λ4 of the optical signals dropped and added by the first and the second wavelength division multiplexer 204 and 206 in the bi-directional optical add-drop multiplexer shown in FIG. 2, respectively.

In this way, the first wavelength division multiplexer 204 demultiplexes the WDM optical signal having wavelengths of λ1, λ3 and λ5 introduced through the first optical transmission line 200, drops and outputs the optical signal having the wavelength of λ3 to a first node 208a of the first optical circulator 208. The remaining WDM optical signal having wavelengths of λ1 and λ5 passes through the first wavelength division multiplexer 204 and is introduced to the second wavelength division multiplexer 206. The first wavelength division multiplexer 204 adds an optical signal having the wavelength of λ4 introduced from the first node 208a of the first optical circulator 208 to the optical signal having the wavelength of λ2 and λ6 introduced from the second wavelength division multiplexer 206. The multiplexed signal is then transmitted through the first optical transmission line 200. The second wavelength division multiplexer 206 demultiplexes the WDM optical signal having wavelengths of λ2, λ3 and λ6 introduced through the second optical transmission line 202, drops and outputs the optical signal having the wavelength of λ3 to a first node 210a of the second optical circulator 210. The remaining WDM optical signal having wavelengths of λ2 and λ6 passes through the second wavelength division multiplexer 206 and is introduced to the first wavelength division multiplexer 204. The second wavelength division multiplexer 206 adds an optical signal having the wavelength of λ4 introduced from the first node 210a of the second optical circulator 210 to the WDM optical signal having the wavelength of λ1 and λ5 introduced from the first wavelength division multiplexer 204. The multiplexed signal is then transmitted through the second optical transmission line 202.

Each of the first and the second optical circulator 208 and 210 is a 3-port optical circulator having circularly arranged three ports. An optical signal introduced through each port is output to an adjacent port located next to the input port in a clockwise or counterclockwise direction as shown by clockwise or counterclockwise arrows in FIG. 2. The first optical circulator 208 separates routes of the signals added and dropped by the first wavelength division multiplexer 204 from each other, and the second optical circulator 210 separates routes of the signals added and dropped by the second wavelength division multiplexer 206 from each other.

The optical signal having the wavelength of λ3 dropped by the first wavelength division multiplexer 204 and applied to the first node 208a of the first optical circulator 208 is output through a second node 208b of the first optical circulator 208. The optical signal having the wavelength of λ4 to be added by the first wavelength division multiplexer 204 is introduced to a third node 208c of the first optical circulator 208 and is then applied through the first node 208a of the first optical circulator 208 to the first wavelength division multiplexer 204. The optical signal having the wavelength of λ3 dropped by the second wavelength division multiplexer 206 and applied to the first node 210a of the second optical circulator 210 is output through a second node 210b of the second optical circulator 210. The optical signal having the wavelength of λ4 to be added by the second wavelength division multiplexer 206 is introduced to a third node 210c of the second optical circulator 210 and is then applied through the first node 210a of the second optical circulator 210 to the second wavelength division multiplexer 206.

In this way, the first wavelength division multiplexer 204 drops the optical signal having the wavelength of λ3 from the WDM optical signal having wavelengths of λ1, λ3 and λ5 introduced through the first optical transmission line 200. The second wavelength division multiplexer 206 adds the optical signal having the wavelength of λ4 to the WDM optical signal having wavelengths of λ1 and λ5, and then transmits the WDM optical signal having wavelengths of λ1, λ4 and λ5 through the second optical transmission line 202. The second wavelength division multiplexer 206 drops the optical signal having the wavelength of λ3 from the WDM optical signal having wavelengths of λ2, λ3 and λ6 introduced through the second optical transmission line 202. The first wavelength division multiplexer 204 adds the optical signal having the wavelength of λ4 to the WDM optical signal having wavelengths of λ2 and λ6, and then transmits the WDM optical signal having wavelengths of λ2, λ4 and λ6 through the first optical transmission line 200. The routes of the signals added and dropped by the first wavelength division multiplexer 204 are separated from each other by the first optical circulator 208, and the routes of the signals added and dropped by the second wavelength division multiplexer 206 are separated from each other by the second optical circulator 210.

As described above, the first wavelength division multiplexer 204 and the first optical circulator 208 perform the dropping and adding for one of the two WDM optical signals transmitted in opposite directions and the second wavelength division multiplexer 206 and the second optical circulator 210 perform the dropping and adding for the other of the two WDM optical signals transmitted in opposite directions. The optical signals dropped and added by the first wavelength division multiplexer 204 and the first optical circulator 208 have wavelengths different from each other, and the optical signals dropped and added by the second wavelength division multiplexer 206 and the second optical circulator 210 have wavelengths different from each other.

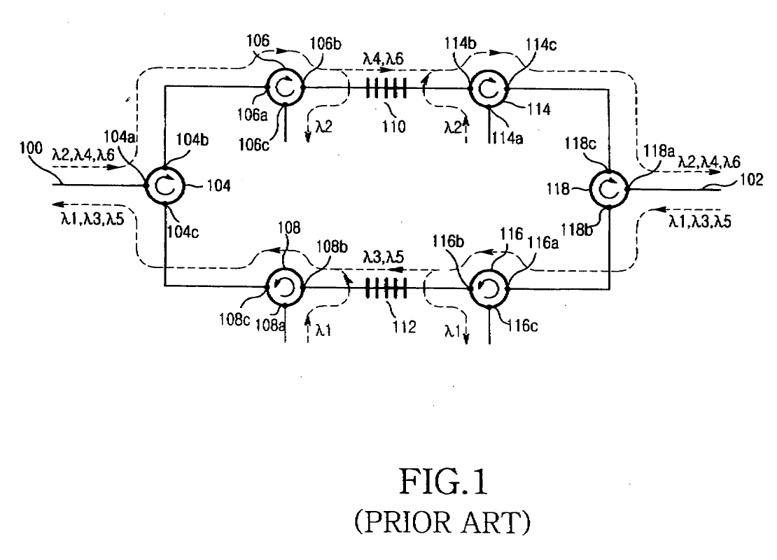

This arrangements reduces and/or prevents the added optical signal from degrading the quality of the dropped optical signal. Therefore, even when the first and the second wavelength division multiplexer 204 and 206 have an isolation lower than that of the optical wavelength selectors 110 and 112 in FIG. 1, the first and the second wavelength division multiplexer 204 and 206 do not degrade the quality of the optical signal. Experiments by the inventors showed that even a low-priced wavelength division multiplexer having an isolation of about 15dB can sufficiently prevent not only crosstalk by optical elements but also generation of relative intensity in the bi-directional WDM system.

Moreover, in the conventional bi-directional optical add-drop multiplexer shown in FIG. 1, two optical circulators and one optical wavelength selector are necessary in order to add and drop one optical signal, so six optical circulators and two optical wavelength selectors are required in total. However, the bidirectional optical add-drop multiplexer according to the embodiment of the present invention as shown in FIG. 2 requires only two wavelength division multiplexers and two optical circulators. This means that a reduced number of optical elements, which simplify the construction of the multiplexer and reduced the manufacturing cost for the multiplexer, are needed.

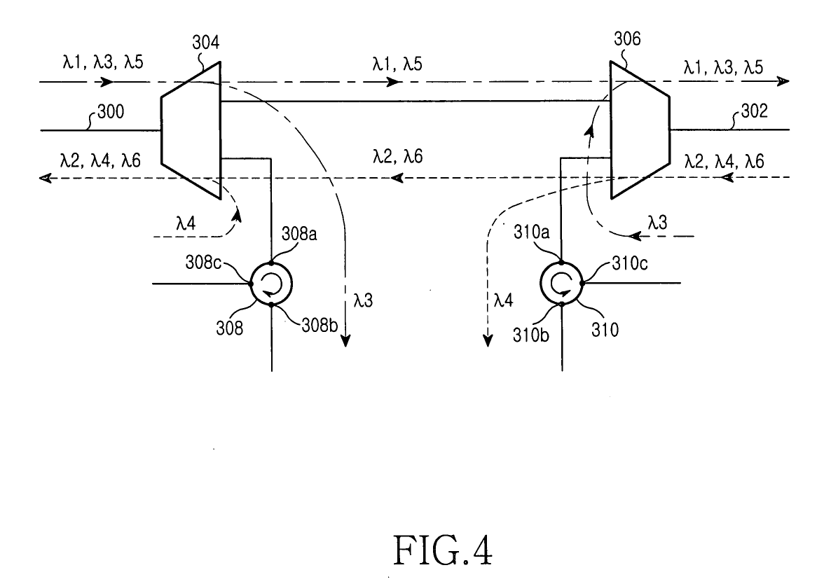

FIG. 4 shows a bi-directional optical add-drop multiplexer according to another embodiment of the present invention. In FIG. 4, two added optical signals in both directions have different wavelengths and two dropped optical signals in both directions have different wavelengths are shown. In the construction shown in FIG. 2, signals dropped and added by each wavelength division multiplexer may be set to have the same wavelength.

The bi-directional optical add-drop multiplexer shown in FIG. 4 includes a couple of optical elements including a first wavelength division multiplexer 304 and a first optical circulator 308 connected to each other and another couple of optical elements including of a second wavelength division multiplexer 306 and a second optical circulator 310 connected to each other. However, as opposed to the bi-directional optical add-drop multiplexer shown in FIG. 2, an optical signal in which three optical signals having wavelengths of λ1, λ3 and λ5 have been wavelength-division-multiplexed is introduced through a first optical transmission line 300 and an optical signal in which three optical signals having wavelengths of λ2, λ4 and λ6 have been wavelength-division-multiplexed is introduced through a second optical transmission line 302 in the bi-directional optical add-drop multiplexer shown in FIG. 4. Further, an optical signal having a wavelength of λ3 is dropped from and an optical signal having a wavelength of λ4 is then added to the WDM optical signal having wavelengths of λ1, λ3 and λ5, while an optical signal having a wavelength of λ4 is dropped from and an optical signal having a wavelength of λ3 is then added to the WDM optical signal having wavelengths of λ2, λ4 and λ6.

In the bidirectional optical add-drop multiplexer shown in FIG. 4, the WDM optical signal having wavelengths of λ1, λ3 and λ5 is introduced to the first wavelength division multiplexer 304 through the first optical transmission line 300. The WDM optical signal having wavelengths of λ2, λ4 and λ6 introduced is introduced to the second wavelength division multiplexer 306 through the second optical transmission line 302. Each of the first wavelength division multiplexer 304 and the second wavelength division multiplexer 306 demultiplexes an introduced WDM optical signal to drop an optical signal having a predetermined wavelength and allow optical signals having the other wavelengths to pass through it, and adds an optical signal having a predetermined wavelength to an introduced WDM optical signal through multiplexing. Each of the first and the second wavelength division multiplexer 304 and 306 has an add-drop filter characteristic capable of selectively dropping and adding only optical signals having predetermined adjacent wavelengths of λi and λi+1as shown in FIG. 3. The second wavelength division multiplexer 306 is a wavelength division multiplexer is also capable of adding an optical signal having a wavelength of λ3 and dropping adding an optical signal having a wavelength of λ4.

The first wavelength division multiplexer 304 and the first optical circulator 308 operates in nearly the same way as that of the first wavelength division multiplexer 204 and the first optical circulator 208. The first wavelength division multiplexer 304 demultiplexes the WDM optical signal having wavelengths of λ1, λ3 and λ5 introduced through the first optical transmission line 300, drops and outputs the optical signal having the wavelength of λ3 to a first node 308a of the first optical circulator 308. The remaining WDM optical signal having wavelengths of λ1 and λ5 passes through the first wavelength division multiplexer 304 and is introduced to the second wavelength division multiplexer 306. As a result, the optical signal having the wavelength of λ3 is output along a drop route out of a second node 308b of the first optical circulator 308. An optical signal having the wavelength of λ4 to be added by the first wavelength division multiplexer 304 is introduced to a third node 308c of the first optical circulator 308 and is applied to the first wavelength division multiplexer 304 through the first node 308a of the first optical circulator 308. The first wavelength division multiplexer 304 adds the optical signal having the wavelength of λ4 introduced from the first node 308a of the first optical circulator 308 to the optical signal having the wavelength of λ2 and λ6 introduced from the second wavelength division multiplexer 306 by multiplexing, and then transmits the multiplexed signal through the first optical transmission line 300.

The second wavelength division multiplexer 306 demultiplexes the WDM optical signal having wavelengths of λ2, λ4 and λ6 introduced through the second optical transmission line 302, drops and outputs the optical signal having the wavelength of λ4 to a first node 310a of the second optical circulator 310. The remaining WDM optical signal having wavelengths of λ2 and λ6 passes through the second wavelength division multiplexer 306 and is introduced to the first wavelength division multiplexer 304. As a result, the optical signal having the wavelength of λ4 is output along a drop route out of a second node 310b of the second optical circulator 310. An optical signal having the wavelength of λ3 to be added by the second wavelength division multiplexer 306 is introduced to a third node 310c of the second optical circulator 310 and is then applied to the second wavelength division multiplexer 306 through the first node 310a of the second optical circulator 310. The second wavelength division multiplexer 306 adds an optical signal having the wavelength of λ3 introduced from the first node 310a of the second optical circulator 310 to the WDM optical signal having the wavelength of λ1 and λ5 introduced from the first wavelength division multiplexer 304 by multiplexing. The multiplexed signal is then transmitted through the second optical transmission line 302.

In this way, the first wavelength division multiplexer 304 and the first optical circulator 308 perform the dropping and adding for one of the two WDM optical signals transmitted in opposite directions and the second wavelength division multiplexer 306. The second optical circulator 310 perform the dropping and adding for the other of the two WDM optical signals transmitted in opposite directions. Here, the optical signals dropped and added by the first wavelength division multiplexer 304 and the first optical circulator 308 have wavelengths different from each other and the optical signals dropped and added by the second wavelength division multiplexer 306 and the second optical circulator 310 also have wavelengths different from each other.

In the bi-directional optical add-drop multiplexer shown in FIG. 2, the added optical signals having the wavelength of λ4 having been transmitted respectively through the first and the second optical transmission line 200 and 202 may be transmitted back by reflection and then dropped by the first and the second wavelength division multiplexer 204 and 206, thereby functioning as an interband crosstalk on the normally dropped optical signal having the wavelength of λ3. The reason why the returning optical signals having the wavelength of λ4 are dropped respectively by the first and the second wavelength division multiplexer 204 and 206 is because the first and the second wavelength division multiplexer 204 and 206 have an add-drop filter characteristic for two optical signals having adjacent wavelengths of λi and λi+1.

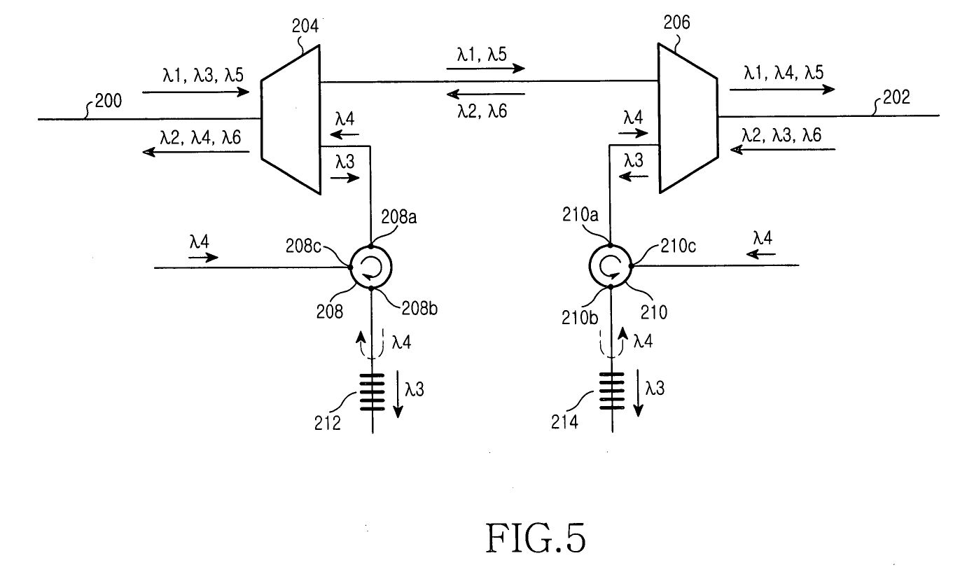

FIG. 5 is a diagram showing a bi-directional optical add-drop multiplexer according to another embodiment of the present invention, which includes a first and a second optical wavelength selector 212 and 214 in addition to the elements of the bi-directional optical add-drop multiplexer shown in FIG. 2. The first optical wavelength selector 212 is connected to the second node 208b of the first optical circulator 208 and the second optical wavelength selector 214 is connected to the second node 210b of the second optical circulator 210. Each of the first and the second optical wavelength selector 212 and 214 is an optical wavelength selector having a reflection wavelength of λ4, which reflects an optical signal having a wavelength of λ4 and allows optical signals having the other wavelengths to pass through the selector. Fiber Bragg gratings, multi-layer thin film elements, optical elements having a grating structure, etc., may be employed as the optical wavelength selector.

If an optical signal having a wavelength of λ4 added by the first wavelength division multiplexer 204 and transmitted through the first optical transmission line 200 is returned by reflection and is then dropped by the first wavelength division multiplexer 204, the optical signal having a wavelength of λ4 is applied to the first node 208a of the first optical circulator 208 together with a normally dropped optical signal having a wavelength of λ3. Then, not only the normally dropped optical signal having a wavelength of λ3 but also the reflected optical signal having a wavelength of λ4 is output through the second node 208b of the first optical circulator 208. However, the normally dropped optical signal having a wavelength of λ3 is output through the first optical wavelength selector 212, while the reflected optical signal having a wavelength of λ4 is reflected again and prevented from being output through the drop route by the first optical wavelength selector 212.

In the same manner, if an optical signal having a wavelength of λ4 added by the second wavelength division multiplexer 206 and transmitted through the second optical transmission line 202 is returned by reflection and is then dropped by the second wavelength division multiplexer 206, the optical signal having a wavelength of λ4 is applied to the first node 210a of the second optical circulator 210 together with a normally dropped optical signal having a wavelength of λ3. Then, not only the normally dropped optical signal having a wavelength of λ3 but also the reflected optical signal having a wavelength of λ4 is output through the second node 210b of the second optical circulator 210. However, the normally dropped optical signal having a wavelength of λ3 is output through the second optical wavelength selector 214, while the reflected optical signal having a wavelength of λ4 is reflected again and prevented from being output through the drop route by the second optical wavelength selector 214.

Therefore, even when the optical signals having the wavelength of λ4 added by the first and the second wavelength division multiplexer 204 and 206 and transmitted through the first and the second optical transmission line 200 and 202 are returned by reflection and are then dropped by the first and the second wavelength division multiplexer 204 and 206, they are prevented from being output through the drop routes and causing interband crosstalk on the normally dropped optical signal having the wavelength of λ3. Further, each of the optical signals reflected by the first and the second optical wavelength selector 212 and 214 has a relatively lower power than that of the normally dropped optical signal since each of the reflected optical signals is a portion of the added optical signal, which has returned by reflection. Therefore, even a low-priced wavelength division multiplexer having an isolation of about 15 dB can be employed as the first and the second optical wavelength selector 212 and 214, like the first and the second wavelength division multiplexer 204 and 206.

The interband crosstalk due to an optical crosstalk as described above may occur also in the bi-directional optical add-drop multiplexer shown in FIG. 4. Therefore, like the bi-directional optical add-drop multiplexer shown in FIG. 5, the bi-directional optical add-drop multiplexer shown in FIG. 4 also may include two optical wavelength selectors in order to prevent interband crosstalk due to optical reflection. In that case, the second node 308b of the first optical circulator 308 is connected to an optical wavelength selector having a reflection wavelength of λ4 and the second node 310b of the second optical circulator 310 is connected to an optical wavelength selector having a reflection wavelength of λ3.

In order to add and drop multiple pairs of optical signals, the bi-directional optical add-drop multiplexer includes the same number of couples of the first wavelength division multiplexer 204 and the first optical circulator 208 shown in FIG. 2 and the same number of couples of the second wavelength division multiplexer 206 and the second optical circulator 210 shown in FIG. 2 as the number of the pairs of the optical signals to be added and dropped. Of course, the wavelength division multiplexers additionally included in the bi-directional optical add-drop multiplexer is required to have an add-drop characteristic for the wavelengths to be added and dropped.

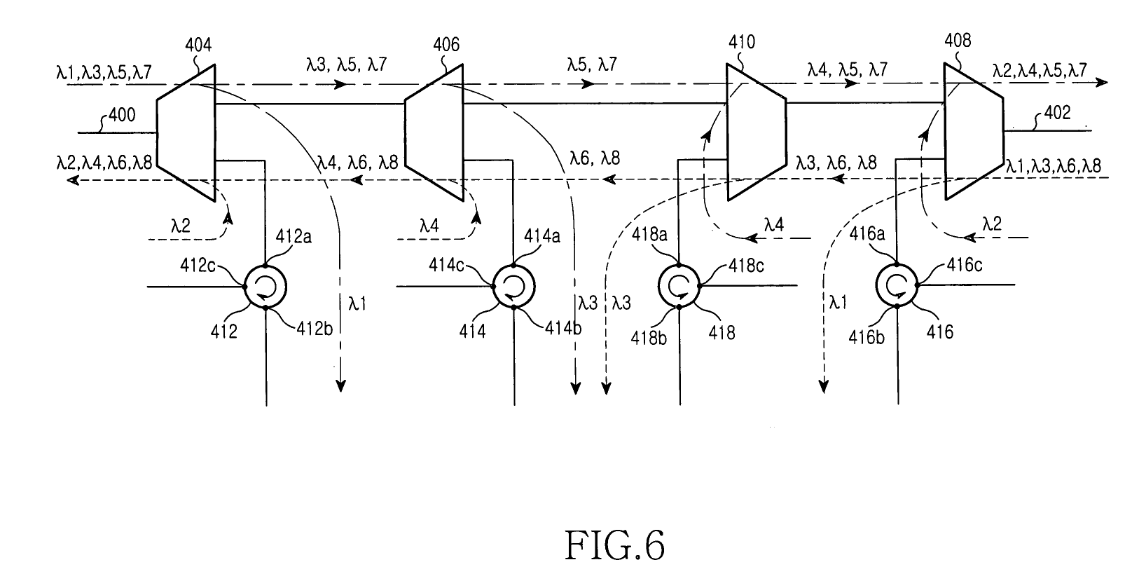

FIG. 6 is a diagram showing a bi-directional optical add-drop multiplexer according to another embodiment of the present invention, in which multiple wavelengths, specifically two wavelengths, are added and dropped. In the bi-directional optical add-drop multiplexer shown in FIG. 6, an optical signal in which optical signals having wavelengths of λ1, λ3, λ5 and λ7 have been wavelength-division-multiplexed is introduced through a first optical transmission line 400. An optical signal in which optical signals having wavelengths of λ1, λ3, λ6 and λ8 have been wavelength-division-multiplexed is introduced through a second optical transmission line 402. Optical signals having wavelengths of λ1 and λ3, respectively, are sequentially dropped from and optical signals having wavelengths of λ4 and λ2, respectively, are then sequentially added to the WDM optical signal having wavelengths of λ1, λ3, λ5 and λ7. Optical signals having wavelengths of λ1 and λ3, respectively, are sequentially dropped from and optical signals having wavelengths of λ4 and λ2, respectively, are then sequentially added to the WDM optical signal having wavelengths of λ1, λ3, λ6 and λ8.

The bi-directional optical add-drop multiplexer shown in FIG. 6 includes one couple of first optical wavelength division multiplexer and first optical circulator and one couple of second optical wavelength division multiplexer and second optical circulator in addition to the elements of the bi-directional optical add-drop multiplexer shown in FIG. 2. Specifically, two first wavelength division multiplexers 404 and 406 are connected in series to the first optical transmission line 400, two second wavelength division multiplexers 408 and 410 are connected in series to the second optical transmission line 402, and the first wavelength division multiplexer 406 and the second wavelength division multiplexer 410 are connected with each other. The first and the second wavelength division multiplexers 404 and 406 have add-drop ports connected to first nodes 412a and 414a of first optical circulators 412 and 414, respectively. The second wavelength division multiplexers 408 and 410 have add-drop ports connected to first nodes 416a and 418a of second optical circulators 416 and 418, respectively. The first wavelength division multiplexers 404 and 406 have add wavelengths of λ2 and λ4 and drop wavelengths of λ1 and λ3, and the second wavelength division multiplexers 408 and 410 have add wavelengths of λ2 and λ4 and drop wavelengths of λ1 and λ3.

The optical signals having the wavelengths of λ1 and λ3 are sequentially dropped from the WDM optical signal having wavelengths of λ1, λ3, λ5 and λ7 introduced through the first optical transmission line 400 while the WDM optical signal having wavelengths of λ1, λ3, λ5 and λ7 sequentially passes through the first wavelength division multiplexers 404 and 406. The WDM optical signal having the other wavelengths of λ5 and λ7 is introduced to the second wavelength division multiplexer 410. The optical signal having the wavelength of λ1 dropped by the first wavelength division multiplexer 404 is applied to the first node 412a of the first optical circulator 412 and is then output through a second node 412b of the first optical circulator 412. The optical signal having the wavelength of λ3 dropped by the first wavelength division multiplexer 406 is applied to the first node 414a of the first optical circulator 414 and is then output through a second node 414b of the first optical circulator 414.

The optical signals having the wavelengths of λ2 and λ4 to be added by the first wavelength division multiplexers 404 and 406 are introduced to third nodes 412c and 414c of the first optical circulators 412 and 414 and are then introduced to the first wavelength division multiplexers 404 and 406 through the first nodes 412a and 414a, respectively. The first wavelength division multiplexer 406 adds an optical signal having a wavelength of λ4 introduced from the first node 414a of the first optical circulator 414 to the WDM optical signal having the wavelengths of λ6 and λ8 introduced from the second wavelength division multiplexer 410 by multiplexing and then applies the resultant WDM optical signal having the wavelengths of λ4, λ6 and λ8 to the first wavelength division multiplexer 404. The first wavelength division multiplexer 404 adds an optical signal having a wavelength of %2 introduced from the first node 412a of the first optical circulator 412 to the WDM optical signal having the wavelengths of λ4, λ6 and λ8 introduced from the first wavelength division multiplexer 406 by multiplexing and then applies the resultant WDM optical signal having the wavelengths of λ2, λ4, λ6 and λ8 through the first optical transmission line 400.

The optical signals having the wavelengths of λ1 and λ3 are sequentially dropped from the WDM optical signal having wavelengths of λ1, λ3, λ6 and λ8 introduced through the second optical transmission line 402 while the WDM optical signal having wavelengths of λ1, λ3, λ6 and λ8 sequentially passes through the second wavelength division multiplexers 408 and 410. The WDM optical signal having the other wavelengths of λ6 and λ8 is introduced to the first wavelength division multiplexer 406. The optical signal having the wavelength of λ1 dropped by the second wavelength division multiplexer 408 is applied to the first node 416a of the second optical circulator 416 and is then output through a second node 416b of the second optical circulator 416. The optical signal having the wavelength of λ3 dropped by the second wavelength division multiplexer 410 is applied to the first node 418a of the second optical circulator 418 and is then output through a second node 418b of the second optical circulator 418.

The optical signals having the wavelengths of λ2 and λ4 to be added by the second wavelength division multiplexers 408 and 410 are introduced to third nodes 416c and 418c of the second optical circulators 416 and 418 and are then introduced to the second wavelength division multiplexers 408 and 410 through the first nodes 416a and 418a, respectively. The second wavelength division multiplexer 410 adds an optical signal having a wavelength of λ4 introduced from the first node 418a of the second optical circulator 418 to the WDM optical signal having the wavelengths of λ5 and λ7 introduced from the first wavelength division multiplexer 406 by multiplexing and then applies the resultant WDM optical signal having the wavelengths of λ4, λ5 and λ7 to the second wavelength division multiplexer 408. The second wavelength division multiplexer 408 adds an optical signal having a wavelength of λ2 introduced from the first node 416a of the second optical circulator 416 to the WDM optical signal having the wavelengths of λ4, λ5 and λ7 introduced from the second wavelength division multiplexer 410 by multiplexing and then applies the resultant WDM optical signal having the wavelengths of λ2, λ4, λ5 and λ7 through the second optical transmission line 402.

The bi-directional optical add-drop multiplexer shown in FIG. 6 as described above may also include an optical wavelength selectors as shown in FIG. 5, in order to prevent occurrence of interband crosstalk, which may be otherwise caused by reflection of the added optical signal.

In addition, in order to add and drop multiple pairs of optical signals, a bi-directional optical add-drop multiplexer may be arranged so that the signals added in the opposite directions have different wavelengths and the signals dropped in the opposite directions have different wavelengths while the signals added and dropped in each direction have the same wavelength, as opposed to the bi-directional optical add-drop multiplexer shown in FIG. 6. In this way, the bi-directional optical add-drop multiplexer may include the same number of couples of the first wavelength division multiplexer 304 and the first optical circulator 308 shown in FIG. 3 and the same number of couples of the second wavelength division multiplexer 306 and the second optical circulator 310 shown in FIG. 3 as the number of the pairs of the optical signals to be added and dropped. Of course, in this case also, the wavelength division multiplexers additionally included in the bi-directional optical add-drop multiplexer should have an add-drop characteristic for the wavelengths to be added and dropped. Also, like the bi-directional optical add-drop multiplexer shown in FIG. 5, this bi-directional optical add-drop multiplexer may additionally include two optical wavelength selectors in order to prevent interband crosstalk due to optical reflection.

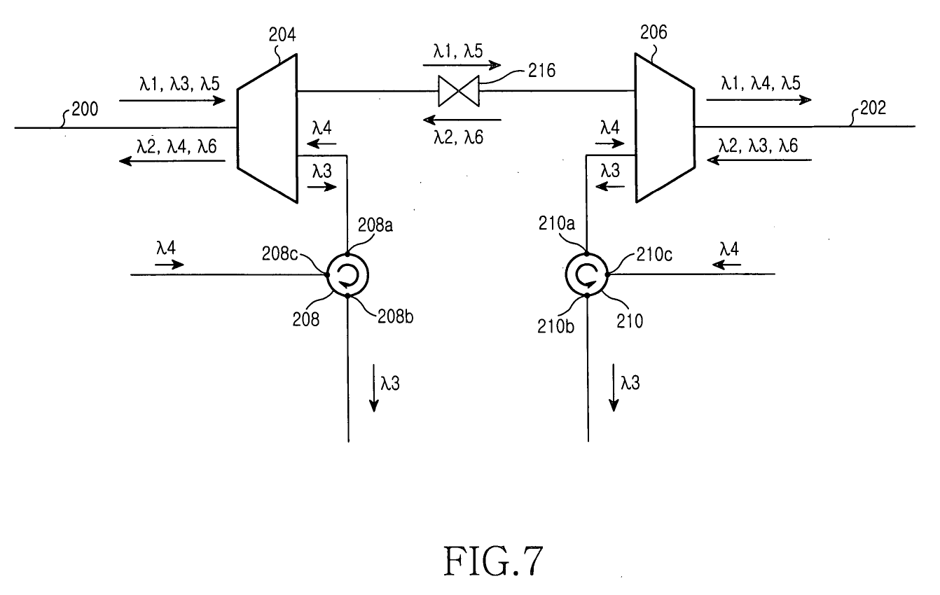

FIG. 7 is a diagram showing a bidirectional optical add-drop multiplexer according to another embodiment of the present invention, which includes a bi-directional optical amplifier 216 disposed between the first and the second wavelength division multiplexer 204 and 206 in addition to the elements of the bi-directional optical add-drop multiplexer shown in FIG. 2. The bi-directional optical amplifier 216 amplifies optical signals transmitted between the first and the second wavelength division multiplexer 204 and 206. This compensates for the optical power of the optical signals lost while the optical signals pass through the first and the second wavelength division multiplexer 204 and 206. In another embodiment, the bi-directional optical add-drop multiplexer may include two bi-directional optical amplifiers 216 disposed between the first optical transmission line 200 and the first wavelength division multiplexer 204 and between the second optical transmission line 202 and the second wavelength division multiplexer 206, respectively. In order to avoid installation of two bi-directional optical amplifiers 216, it is preferred to locate a bi-directional optical amplifier 216 between the first and the second wavelength division multiplexer 204 and 206. Such a construction for compensating for lost optical power by one or more bi-directional optical amplifiers may be employed in either the bi-directional optical add-drop multiplexers or modified bi-directional optical add-drop multiplexers thereof.

The above-described embodiments shows examples in which optical signals having one or two wavelengths are added and dropped from two WDM optical signals having three or four wavelengths transmitted in opposite directions. However, multiplexed wavelengths, the number of the multiplexed wavelengths, added or dropped wavelengths, and the number of the added or dropped wavelengths may be changed according to bi-directional optical add-drop multiplexers to which the embodiments of present invention are actually applied. Also, embodiments of the present invention may be applied to even variable wavelength division multiplexers having variable multiplexed or demultiplexed wavelengths. Embodiments of the present invention may also employ a wavelength-variable optical wavelength selector having a variable reflection wavelength.

Therefore, while the invention has been shown and described with reference to certain embodiments thereof, it will be understood by those skilled in the art that various changes in form and details may be made therein without departing from the spirit and scope of the invention as defined by the appended claims.

What is claimed is:

1. A bi-directional optical add-drop multiplexer comprising:
a first wavelength division multiplexer arranged to demultiplex a first WDM optical signal introduced through a first optical transmission line, dropping a first demultiplexed optical signal having a first wavelength from the first WDM optical signal while allowing remaining demultiplexed optical signals of the first WDM optical signal to pass through the first wavelength division multiplexer and be introduced to a second wavelength division multiplexer, multiplex a first add optical signal having a second wavelength to remaining demultiplexed optical signals of a second WDM optical signal having passed through the second wavelength division multiplexer, and transmit the multiplexed optical signals to the first optical transmission line,
wherein the second wavelength division multiplexer arranged to demultiplex the second WDM optical signal introduced from a second optical transmission line, drop a second demultiplexed optical signal having a third wavelength from the second WDM optical signal while allowing the remaining demultiplexed optical signals of the second WDM optical signal to pass through the second wavelength division multiplexer and be introduced to the first wavelength division multiplexer, multiplex a second add optical signal having a fourth wavelength to the remaining demultiplexed optical signals of the first WDM optical signal having passed through the first wavelength division multiplexer, and transmit the added optical signals to the second transmission line;
a first optical circulator having a first port, a second port and a third port, in which the first demultiplexed optical signal dropped by the first wavelength division multiplexer is introduced through the first port of the first optical circulator and is then output through the second port of the first optical circulator and the first add optical signal to be added by the first wavelength division multiplexer is introduced through the third port of the first optical circulator and is then output through the first port of the first optical circulator to the first wavelength division multiplexer; and
a second optical circulator having a first port, a second port and a third port, in which the second demultiplexed optical signal dropped by the second wavelength division multiplexer is introduced through the first port of the second optical circulator and is then output through the second port of the second optical circulator and the second add optical signal to be added by the second wavelength division multiplexer is introduced through the third port of the second optical circulator and is then output through the first port of the second optical circulator to the second wavelength division multiplexer.

2. A bi-directional optical add-drop multiplexer as claimed in claim 1, wherein the first optical transmission line and the second optical transmission line connected in series to each other.

3. A bi-directional optical add-drop multiplexer as claimed in claim 2, wherein the first optical transmission line is connected to one node from among a plurality of nodes of a bidirectional optical add-drop multiplexer optical network and the second optical transmission line is connected to another node from among the plurality of nodes.

4. A bi-directional optical add-drop multiplexer as claimed in claim 1, further comprising:
a first optical wavelength selector connected to the second port of the first optical circulator and reflecting an optical signal having a wavelength equal to the second wavelength of the first add optical signal added by the first wavelength division multiplexer from among optical signals output through the second port of the first optical circulator; and
a second optical wavelength selector connected to the second port of the second optical circulator and reflecting an optical signal having a wavelength equal to the fourth wavelength of the second add optical signal added by the second wavelength division multiplexer from among optical signals output through the second port of the second optical circulator.

5. A bi-directional optical add-drop multiplexer as claimed in claim 1, wherein the first wavelength is equal to the third wavelength but is different from the fourth wavelength, and the second wavelength is equal to the fourth wavelength but is different from the third wavelength.

6. A bi-directional optical add-drop multiplexer as claimed in claim 5, further comprising a bi-directional optical amplifier connected between and amplifying optical signals transmitted between the first wavelength division multiplexer and the second wavelength division multiplexer.

7. A bi-directional optical add-drop multiplexer as claimed in claim 1, wherein the first wavelength is equal to the fourth wavelength but is different from the third wavelength, and the second wavelength is equal to the third wavelength but is different from the fourth wavelength.

8. A bi-directional optical add-drop multiplexer as claimed in claim 7, further comprising a bi-directional optical amplifier connected between and amplifying optical signals transmitted between the first wavelength division multiplexer and the second wavelength division multiplexer.

9. A bidirectional optical add-drop multiplexer comprising:
a plurality of first wavelength division multiplexers connected in series to a first optical transmission line, arranged to demultiplex a first WDM optical signal introduced through the first optical transmission line, to sequentially drop a plurality of first demultiplexed optical signals having predetermined wavelengths from the first WDM optical signal while allowing remaining demultiplexed optical signals of the first WDM optical signal to pass through the first wavelength division multiplexer and be introduced to a plurality of second wavelength division multiplexers, to sequentially multiplex a plurality of first add optical signals having predetermined wavelengths to remaining demultiplexed optical signals of the second WDM optical signal having passed through the second wavelength division multiplexers, and transmit the added optical signals to the first optical transmission line, wherein the second wavelength division multiplexers, connected in series to the second optical transmission line, is arranged to demultiplex the second WDM optical signal introduced from a second optical transmission line, drop second demultiplexed optical signals having predetermined wavelengths from the second WDM optical signal while allowing the remaining demultiplexed optical signals of the second WDM optical signal to pass through the second wavelength division multiplexers and be introduced to the first wavelength division multiplexers, multiplex second add optical signals having predetermined wavelengths to the remaining demultiplexed optical signals of the first WDM optical signal having passed through the first wavelength division multiplexers, and transmit the added optical signals to the second optical transmission line;
a plurality of first optical circulators each having a first port, a second port and a third port, in which the first demultiplexed optical signals dropped by the first wavelength division multiplexers are introduced through first ports of the first optical circulators and are then output through second ports of the first optical circulators, respectively, and the first add optical signals to be added by the first wavelength division multiplexers are introduced through third ports of the first optical circulators and are then output through the first port of the first optical circulators to the first wavelength division multiplexers, respectively; and
a plurality of second optical circulators each having a first port, a second port and a third port, in which the second demultiplexed optical signals dropped by the second wavelength division multiplexers are introduced through first ports of the second optical circulators and are then output through second ports of the second optical circulators, respectively, and the second add optical signals to be added by the second wavelength division multiplexers are introduced through third ports of the second optical circulators and are then output through the first ports of the second optical circulators to the second wavelength division multiplexers, respectively.

10. A bi-directional optical add-drop multiplexer as claimed in claim 9, wherein the first optical transmission line and the second optical transmission line connected in series to each other, the first optical transmission line is connected to one node from among a plurality of nodes in a bi-directional optical add-drop multiplexer optical network, the second optical transmission line is connected to another node from among the plurality of nodes.

11. A bi-directional optical add-drop multiplexer as claimed in claim 10, further comprising:
first optical wavelength selectors connected to the second ports of the first optical circulators, respectively, each of the first optical wavelength selectors reflecting an optical signal having a wavelength equal to a corresponding wavelength of the first add optical signals added by the first wavelength division multiplexers from among optical signals output through the second ports of the first optical circulators; and
second optical wavelength selectors connected to the second ports of the second optical circulators, respectively, each of the second optical wavelength selectors reflecting an optical signal having a wavelength equal to a corresponding wavelength of the second add optical signals added by the second wavelength division multiplexers from among optical signals output through the second ports of the second optical circulators.

12. A bi-directional optical add-drop multiplexer as claimed in claim 9, wherein
wavelengths of the first demultiplexed optical signals dropped by the first wavelength division multiplexers are equal to wavelengths of the second demultiplexed optical signals dropped by the second wavelength division multiplexers but are different from wavelengths of the add optical signals added by the second wavelength division multiplexers, and
wavelengths of the first add optical signals added by the first wavelength division multiplexers are equal to wavelengths of the second add optical signals added by the second wavelength division multiplexers but are different from wavelengths of the demultiplexed optical signals dropped by the second wavelength division multiplexers.

13. A bi-directional optical add-drop multiplexer as claimed in claim 12, further comprising a bi-directional optical amplifier connected between and amplifying optical signals transmitted between the first wavelength division multiplexers and the second wavelength division multiplexers.

14. A bi-directional optical add-drop multiplexer as claimed in claim 9, wherein
wavelengths of the first demultiplexed optical signals dropped by the first wavelength division multiplexers are equal to wavelengths of the second add optical signals added by the second wavelength division multiplexers but are different from wavelengths of the demultiplexed optical signals dropped by the second wavelength division multiplexers, and
wavelengths of the first add optical signals added by the first wavelength division multiplexers are equal to wavelengths of the second demultiplexed optical signals dropped by the second wavelength division multiplexers but are different from wavelengths of the add optical signals added by the second wavelength division multiplexers.

15. A bi-directional optical add-drop multiplexer as claimed in claim 14, further comprising a bi-directional optical amplifier connected between and amplifying optical signals transmitted between the first wavelength division multiplexers and the second wavelength division multiplexers.

16. A bidirectional optical add-drop multiplexer comprising:
at least a first and a second wavelength division multiplexer connected to each other,
at least a first optical circulator connected to the first wavelength division multiplexer; and
at least a second optical circulator connected to the second wavelength division multiplexer;
wherein the first wavelength division multiplexer being arranged to demultiplex a first WDM optical signal, drop a first demultiplexed optical signal having a first wavelength from the first WDM optical signal while allowing remaining demultiplexed optical signals of the first WDM optical signal to pass to the second wavelength division multiplexer, multiplex a first add optical signal having a second wavelength to remaining demultiplexed optical signals of a second WDM optical signal having passed through the second wavelength division multiplexer, and output the multiplexed optical signals,
wherein the second wavelength division multiplexer being arranged to demultiplex the second WDM optical signal, drop a second demultiplexed optical signal having a third wavelength from the second WDM optical signal while allowing the remaining demultiplexed optical signals of the second WDM optical signal to pass to the first wavelength division multiplexer, multiplex a second add optical signal having a fourth wavelength to the remaining demultiplexed optical signals of the first WDM optical signal having passed through the first wavelength division multiplexer, and output the added optical signals,
wherein the first optical circulator has a plurality of ports, via which the first demultiplexed optical signal dropped by the first wavelength division multiplexer is received from the first wavelength division multiplexer and the first add optical signal to be added by the first wavelength division multiplexer is input to the first wavelength division multiplexer, and
wherein the second optical circulator has a plurality of ports, via which the second demultiplexed optical signal dropped by the second wavelength division multiplexer is received from second wavelength division multiplexer and the second add optical signal to be added by the second wavelength division multiplexer is input to the second wavelength division multiplexer.
